(19) United States
(12) Patent Application Publication
(10) Pub. No.: US 2017/0324890 A1
(43) Pub. Date: Nov. 9, 2017

(54) Smart Frame for Camera System

(71) Applicant: GoPro, Inc., San Mateo, CA (US)

(72) Inventor: Stepan Moskovchenko, Belmont, CA (US)

(21) Appl. No.: 15/150,418

(22) Filed: May 9, 2016

(51) Int. Cl. H04N 5/225; H04N 5/232

(52) U.S. Cl. CPC H04N 5/2252; H04N 5/23225; H04N 5/2253; H04N 5/23203

(57) ABSTRACT

A camera smart frame is configured to enclose and communicatively couple to a camera. The camera smart frame includes one or more sets of input mechanisms, such as buttons. Each input mechanism can be programmed by a user to perform a selected camera function or configure a camera based on a selected camera configuration. A user can select, via a camera interface, a function or configuration, a smart frame input mechanism, and can associate the selected input mechanism and the selected function or configuration. When the smart frame is subsequently coupled to the camera, and a user interacts with the selected input mechanism, a camera controller identifies the function or configuration associated with the selected input mechanism and configures the camera accordingly.

### BACKGROUND

### Technical Field

This disclosure relates to camera housings, and more specifically, to a smart camera frame that includes interface mechanisms for performing camera functions.

### Description of the Related Art

Digital cameras are increasingly used in outdoors and sports environments. Often, these cameras are coupled to users, sports equipment, or vehicles. In such embodiments, it can be difficult to quickly access various camera interaction mechanisms (such as touch-screen displays) and to navigate camera interfaces (for instance, through multiple camera menus) to configure the camera in a desired mode. Further, cameras often minimize the number of certain camera interaction mechanisms (such as buttons) in order to streamline such interaction mechanisms. Accordingly, configuring a camera often requires a user to be able to view a display and to navigate multiple camera menus using very few interaction mechanisms. Satisfying such requirements may not be possible in high-speed environments that otherwise requires a user's attention and concentration.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1a illustrates a camera 100 for use with the camera systems described herein, according to one example embodiment.

FIG. 1b illustrates a perspective view of a rear of a camera 100 for use with the camera system, according to one embodiment.

FIG. 2 illustrates a perspective view of a camera frame 120, according to one embodiment.

FIG. 3a illustrates a lower mount component uncoupled from a base mount component, according to one embodiment.

FIG. 3b illustrates a lower mount component coupled to a base mount component, according to one embodiment.

FIG. 3c illustrates a camera enclosed within a camera frame, which in turn is coupled to a lower mount component via a turnable handscrew, according to one embodiment.

FIG. 4a illustrates a close-up perspective view of a latch mechanism in an open configuration, according to some embodiments.

FIG. 4b illustrates a close-up perspective view of a latch mechanism in a closed configuration, according to some embodiments.

FIG. 5a illustrates a perspective view of an additional camera frame, according to one embodiment.

FIGS. 5b-5c illustrate perspective views of additional lower mount components, according to various embodiments.

FIG. 6 illustrates an example high-level block diagram of a camera system, according to one embodiment.

FIG. 7 illustrates a perspective view of a smart frame, according to one embodiment.

FIG. 8 is a flowchart illustrating a method of configuring a camera using a smart frame, according to one embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview Configuration

A camera system includes a camera and a camera frame structured to at least partially enclose the camera. The camera comprises a camera body having a camera lens structured on a front surface of the camera body, various indicators on the front of the surface of the camera body (such as LEDs, displays, and the like), various input mechanisms (such as buttons, switches, and touch-screen mechanisms), and electronics (e.g., imaging electronics, power electronics, etc.) internal to the camera body for capturing images via the camera lens and/or performing other functions.

In one embodiment, a camera smart frame is communicatively coupled to the camera. The smart frame includes one or more input mechanisms each configured to, upon interaction by a user, configure a camera according to a pre-determined configuration or camera mode associated with the input mechanism. A camera controller, upon receiving an input via a smart frame input mechanism, can identify a configuration or camera mode corresponding to the configuration or camera mode, and can configure the camera accordingly.

### Example Camera Frame and Camera System Configuration

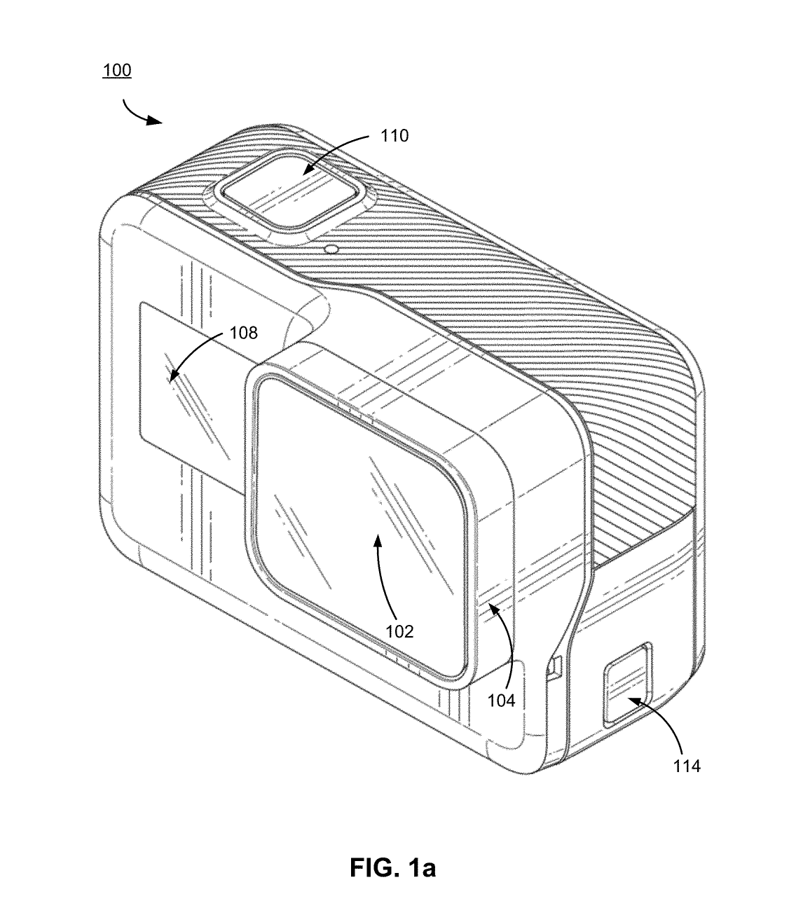

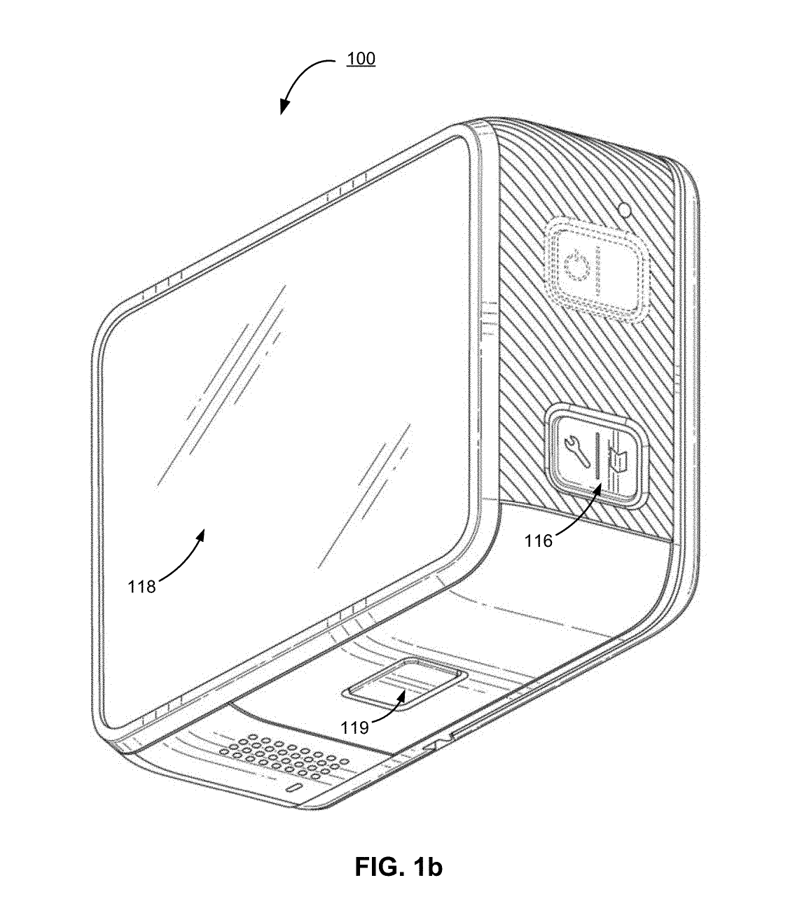

FIG. 1a illustrates a camera 100 for use with the camera systems described herein, according to one example embodiment. The camera 100 is configured to capture images and video, and to store captured images and video for subsequent display or playback. The camera 100 is adapted to fit within a camera housing, such as the camera frame described herein or any other suitable housing. As illustrated, the camera 100 includes a lens 102 configured to receive light incident upon the lens and to direct received light onto an image sensor internal to the lens. The lens 102 is enclosed by a lens ring 104.

The camera 100 can include various indicators, including the LED display 108 shown in FIG. 1a. The camera 100 can also include a shutter button 110 configured to allow a user of the camera to interact with the camera, to capture images and video, and to perform other camera functions. The camera 100 can also include one or more microphones (not shown in FIG. 1a) configured to receive and record audio signals in conjunction with recording video. The side of the camera 100 includes an I/O interface 114. Though the embodiment of FIG. 1a illustrates the I/O interface 114 enclosed by a protective door, the I/O interface can include any type or number of I/O ports or mechanisms, such as USB ports, HDMI ports, memory card slots, and the like.

FIG. 1b illustrates a perspective view of a rear of a camera 100 for use with the camera system, according to one embodiment. The camera 100 includes a button 116 configured to enable a user to interact with the camera, for instance by performing one or more camera functions, by configuring the camera into one or more camera modes, to adjust camera settings, and the like. The camera 100 includes a display 118 configured to display camera information or image information (such as captured images or viewfinder images). In some embodiments, the display 118 comprises a touch-screen display enabling a user of the camera 100 to interact with the camera via the display. The camera also includes an expansion pack interface 119 configured to receive a removable expansion pack, such as a display module, an extra battery module, a wireless module, and the like. Removable expansion packs, when coupled to the camera 100, provide additional functionality to the camera via the expansion pack interface 119.

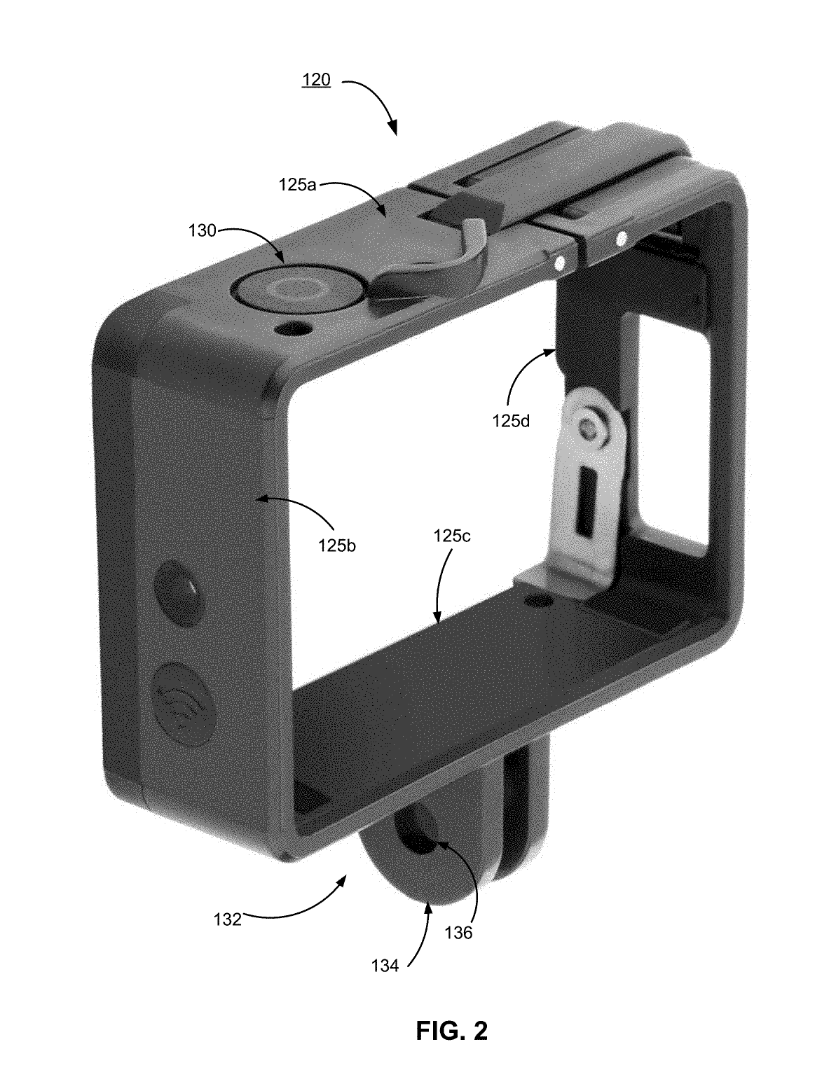

FIG. 2 illustrates a perspective view of a camera frame 120, according to one embodiment. The camera frame 120 includes a top face 125a, a left face 125b, a bottom face 125c, and a right face 125d. The camera frame 120 is configured to enclose around an outside perimeter of a camera (such as the camera 100) such that an inside surface of the top face 125a, of the left face 125b, of the bottom face 125c, and of the right face 125d abut a top surface of the camera, a left surface of the camera, a bottom surface of the camera, and a right surface of the camera, respectively. It should be noted that in some embodiments, the camera frame 120 can additionally include a front face configured to enclose a front face of the camera 100 and a rear face configured to enclose a rear face of the camera. In such embodiments, the camera 100 can be completely enclosed within the frame 120, and the frame can form a water- or air-tight seal around the camera.

The frame 120 further includes an outer shutter button 130 structured so that a shutter button 110 of the camera is substantially aligned with the outer shutter button when the camera 100 is secured within the camera frame 120. The shutter button 110 of the camera 100 is operationally coupled to the outer shutter button 130 so that pressing the outer shutter button allows a user to operate the camera shutter button when the camera is enclosed within the frame 120.

In one embodiment, the camera frame 100 has a small form factor (e.g., a height of approximately 4 to 6 centimeters, a width of approximately 5 to 7 centimeters, and a depth of approximately 1 to 4 centimeters), and is lightweight (e.g., approximately 50 to 150 grams). The camera frame 100 can be rigid (or substantially rigid) (e.g., plastic, metal, fiberglass, etc.) or pliable (or substantially pliable) (e.g., leather, vinyl, neoprene, etc.).

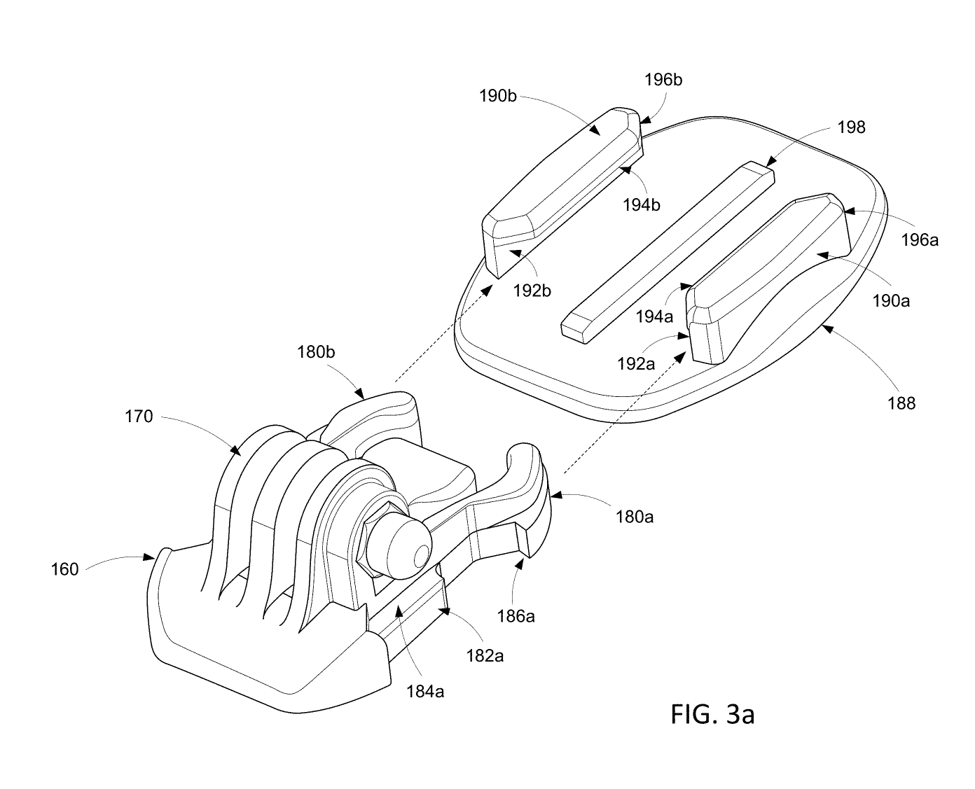

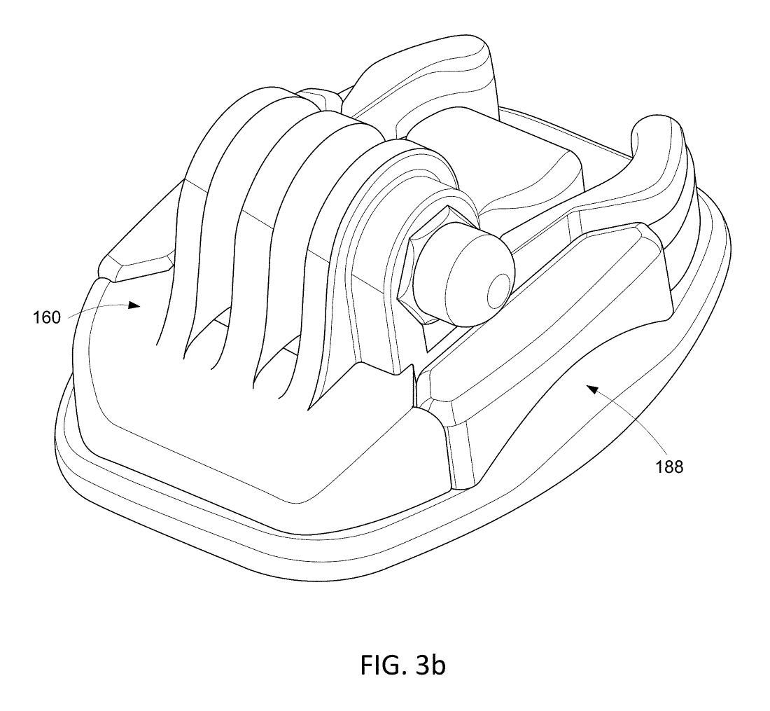

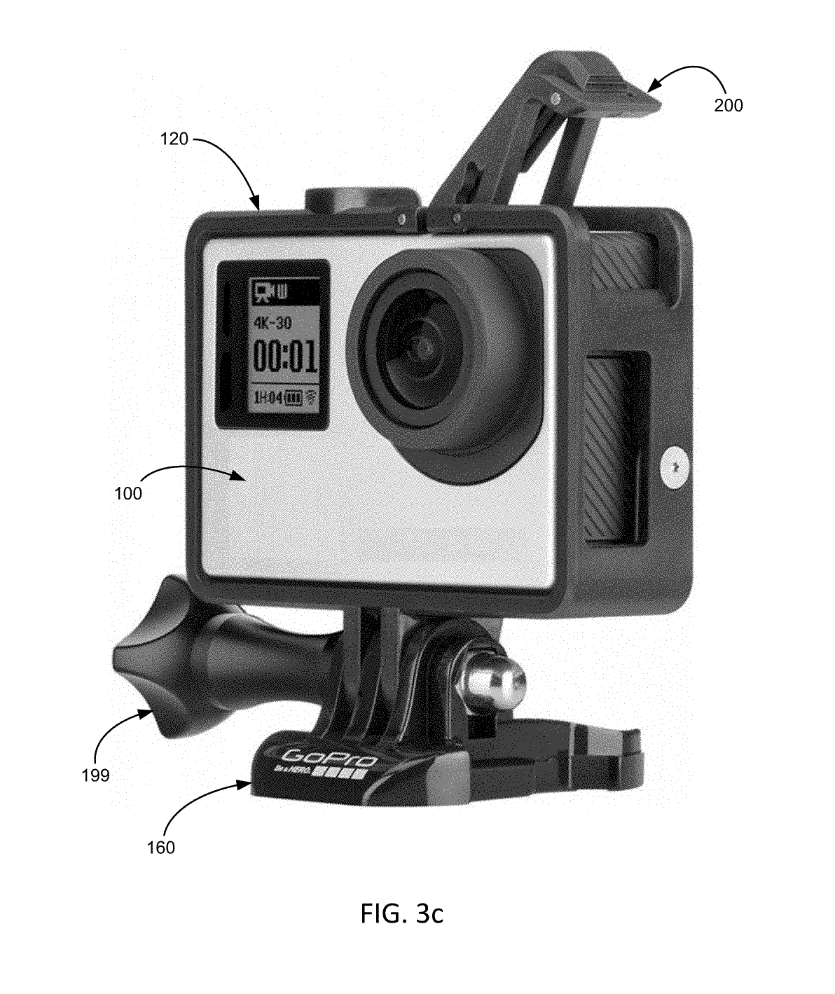

In one embodiment, the camera frame 120 includes one or more securing structures 132 for securing the camera frame to one of a variety of mounting devices. For example, FIG. 2 illustrates the camera frame 120 with a first plurality of protrusions 134 (each with a hold 136) configured to interlock with a second plurality of protrusions (each with a hole) of a lower mount component (as described in FIGS. 3a and 3b) such that the first and second pluralities of protrusions can interlock in such a way that the protrusion holes substantially align. Continuing with this example, a turnable handscrew can be inserted through the aligned holes, coupling the camera frame 120 to the lower mount component such that the camera frame can pivotally rotate relative to the lower mount component when the turnable handscrew is in a first unlocked position, and such that the camera frame is fixed in position relative to the lower mount component when the turnable handscrew is in a second locked position. In other embodiments, the camera frame 120 can be secured to a different type of mounting structure, and can be secured to a mounting structure via a different type of coupling mechanism.

FIG. 3a illustrates a lower mount component uncoupled from a base mount component, according to one embodiment. The lower mount component 160 includes a plurality of protrusions 170. In some embodiments, the plurality of protrusions 170 are configured to interlock with the plurality of protrusions 134 of the camera frame 120 of FIG. 2 such that the holes in each protrusion in the sets of protrusions align. When a screw or pin is inserted into the aligned holes, the camera frame 120 can be rotatably secured to the lower mount component 160.

The lower mount component 160 also includes two prongs 180a and 180b that can be flexibly compressed inward when squeezed. The prongs 180a and 180b include side securing surfaces 182a and 182b (not shown), top securing surfaces 184a and 184b, and securing lips 186a and 186b (not shown), respectively. The base mount component 188 includes securing arms 190a and 190b, each with side securing surfaces 192a and 192b, top securing surfaces 194a and 194b, and back securing surfaces 196a and 196b, respectively. The base mount component additionally includes spine 198.

When the prongs 180a and 180b of the lower mount component 160 are squeezed together, the width of the prong-side of the lower mount component is reduced to less than the width between the securing arms 190a and 190b, such that the lower mount component can be slid onto the base mount component 188. When the lower mount component is slid onto the base mount component 188, the side securing surfaces 182a and 182b make contact with and slide along the side securing surfaces 192a and 192b, respectively. Similarly, the top securing surfaces 184a and 184b make contact with and slide along the top securing surfaces 194a and 194b, respectively. When the lower mount component is completely slid into the base mount component 188, the securing arms decompress outward when the securing lips 186a and 186b are slid past the back securing surfaces 196a and 196b. The securing arms flexibly exert force outward such that the securing lips extend outwards and make contact with the back securing surfaces or overlap at least partially with the back securing surfaces, preventing the lower mount component from sliding backwards and securely coupling the lower mount component to the base mount component as illustrated in FIG. 3b. The lower mount component 160 can be uncoupled from the base mount 188 component by compressing the securing arms of the lower mount component such that the width of the prong-side of the lower mount component is again reduced to less than the width between the securing arms of the base mount component, and sliding the lower mount component backwards past the base mount component.

The lower mount component 160 can include a spine groove on the bottom side of the lower mount component to allow for the reciprocal sliding and insertion of the spine 198 of the base mount component 188 into the spine groove when the lower mount component is slid onto and secured to the base mount component. The spine of the base mount component exerts a force upwards on the lower mount component, forcing the lower mount component upward such that the top securing surfaces 184a and 184b are forced upward into the top securing surfaces 194a and 194b.

The upward force of the lower mount component 160 into the top securing surfaces 194a and 194b of the securing arms 190a and 190b result in the vertical securement of the lower mount component onto the base mount component. In other words, by forcing the lower mount component upwards, the spine 198 prevents any up or down motion by the lower mount component relative to the base mount component. In addition, the upwards force exerted by the spine 198 into the lower mount component (the force exerted by the top securing surfaces 182a and 182b into the top securing surfaces 192a and 192b, respectively), in combination with the coefficient of friction between both the top securing surfaces 182a and 192a and the top securing surfaces 182b and 192b, results in a friction force between the lower mount component and the base mount component. The friction force prevents any horizontal movement of the lower mount component relative to the base mount component resulting from horizontal forces on the lower mount component less than the friction force. Thus, the spine 198 secures the lower mount component onto the base mount component by preventing both the vertical and the horizontal movement of the lower mount component relative to the base mount component.

It should be noted in alternative embodiments, the lower mount component 160 is configured to securely couple to the base mount component 188 using other means than those described with regards to FIGS. 3a and 3b. For example, the lower mount component can include a securing protrusion on the bottom side of the lower mount component configured for insertion into a reciprocal opening within the base mount component, and secured using, for example, a securing pin or other locking mechanism. Similarly, the securing arms 190a and 190b of the base mount component can be compressible or flexible such that the arms can be squeezed apart, the lower mount component can be slid onto the base mount component, and the arms can be released, securely coupling the lower mount component to the base mount component. The lower mount component can be securely coupled to the base mount component using adhesives, buttons, ties, latches, springs, or any combination of the mechanisms described herein. Any other suitable securing mechanism can be used to secure the lower mount component to the base mount component. In addition, as will be described below in greater detail, the lower mount component, the base mount component, or both can be configured to detach such that a camera frame can decouple to the lower mount component or such that the lower mount component can decouple from a base mount component in response to a force exerted on the camera frame, the lower mount component, the base mount component, or any combination thereof.

FIG. 3c illustrates a camera 100 (different than the camera 100 illustrated in FIGS. 1a and 1b) enclosed within a camera frame 120, which in turn is coupled to a lower mount component 160 via the turnable handscrew 199. A first plurality of protrusions of the camera frame 120 are inserted between a second plurality of protrusions of the lower mount component 160. Each protrusion of the first plurality of protrusions and the second plurality of protrusions includes a hole, and the turnable handscrew 199 is inserted through the aligned holes, pivotally coupling the camera frame 120 to the lower mount component 160. The camera frame 120 includes a latch mechanism 200 configured to enable a first portion of the camera frame coupled to a first portion of the latch mechanism to flexibly separate from a second portion of the camera frame coupled to a second portion of the latch mechanism when the latch mechanism is configured in an open configuration (the configuration illustrated in FIG. 3c), thereby enabling a user to insert a camera into or remove a camera from the camera frame. The latch mechanism 200 can also be configured in a closed configured (the configuration illustrated in FIG. 2), thereby securing a camera 100 within the camera frame 120.

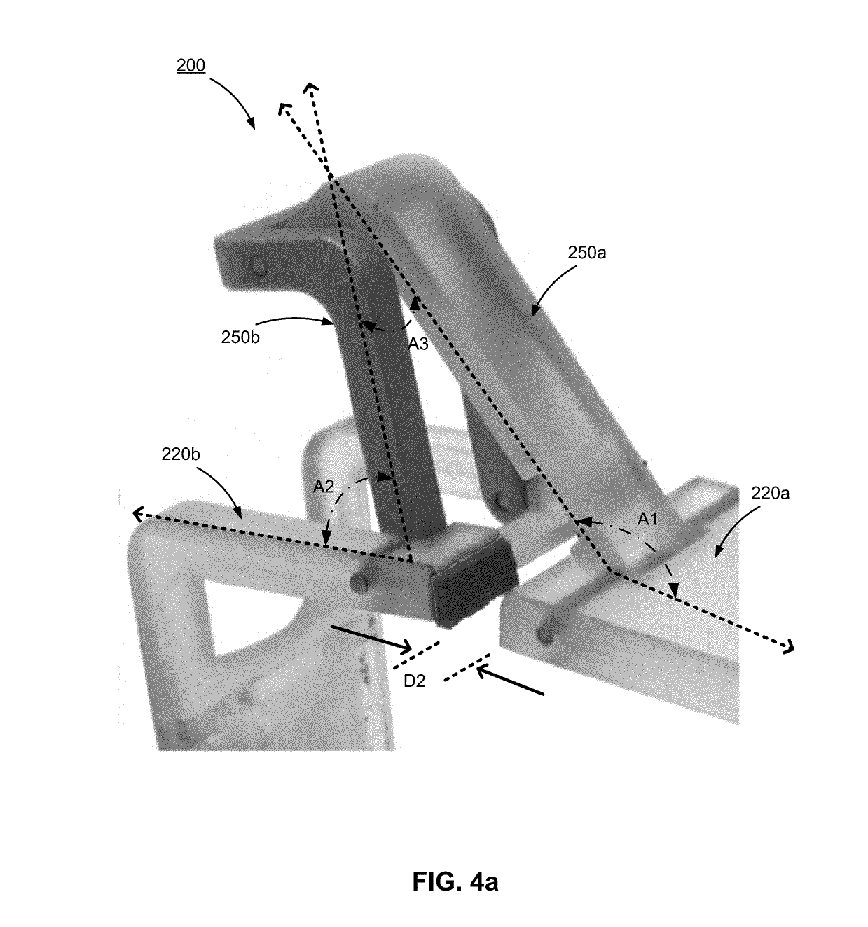

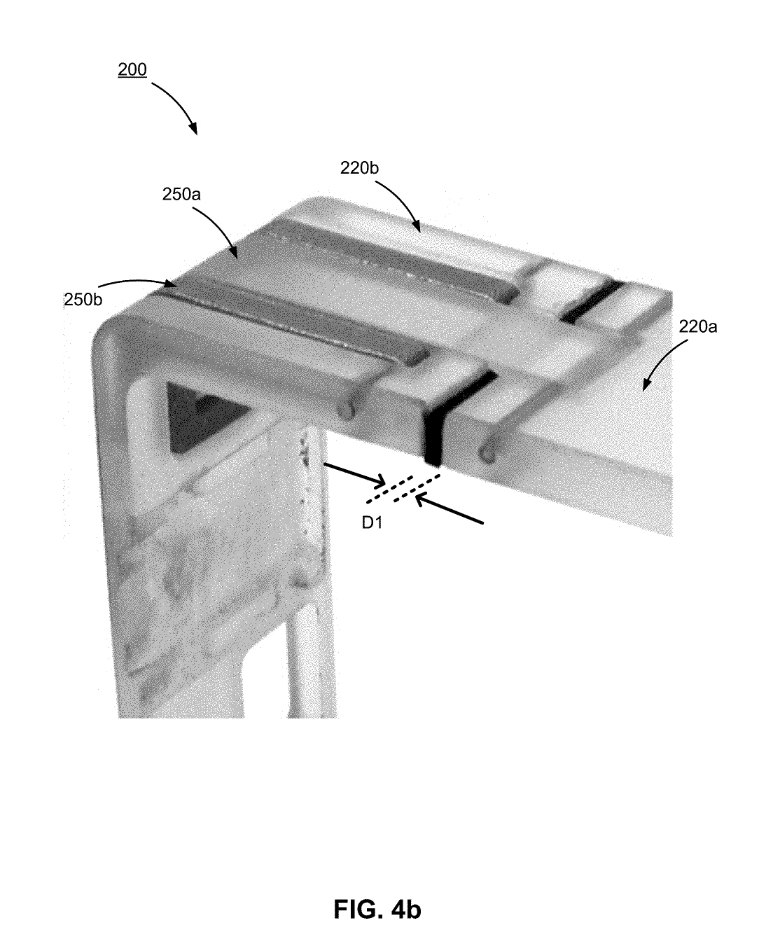

FIG. 4a illustrates a close-up perspective view of latch mechanism 200 in an open configuration, according to some embodiments. As shown in FIG. 4a, the latch components 250a and 250b each form an angular separation relative to the top side of the frame portions 220a and 220b. In some embodiments, the latch component 250a forms an angular separation A1 with respect to the frame portion 220a, the latch component 250b forms an angular separation A2 with respect to the frame portion 220b, and the latch components 250a and 250b form an angular separation A3 with respect to each other. As the latch mechanism 200 is moved from the closed configuration to the open configuration, the angles A2 and A3 increase, and A1 decreases. Likewise, as the frame portions 220a and 220b are separated (indicated by the separation D2), the angle A3 increases.

FIG. 4b illustrates a close-up perspective view of latch mechanism 200 in a closed configuration, according to some embodiments. In the closed configuration, the latch components 250a and 250b are folded down into a reciprocal cavity or opening within the camera frame 120. In such a configuration, the frame portions 220a and 220b are separated by the distance D1, which is less than the distance D2 of FIG. 4a. In some embodiments, a compressible material is appended to one or both of the frame portions 220a and 220b such that the gap defined by distance D1 is filled with the compressible material. As shown in FIGS. 4a and 4b, the latch components 250a and 250b include a substantially right-angled bend, and the reciprocal cavity or opening within the camera frame 120 includes a substantially similar right-angled bend, thereby making the latch components 250a and 250b, when the latch mechanism is configured in the closed configuration, substantially flush with the top surface of the frame and the adjacent side surface of the frame.

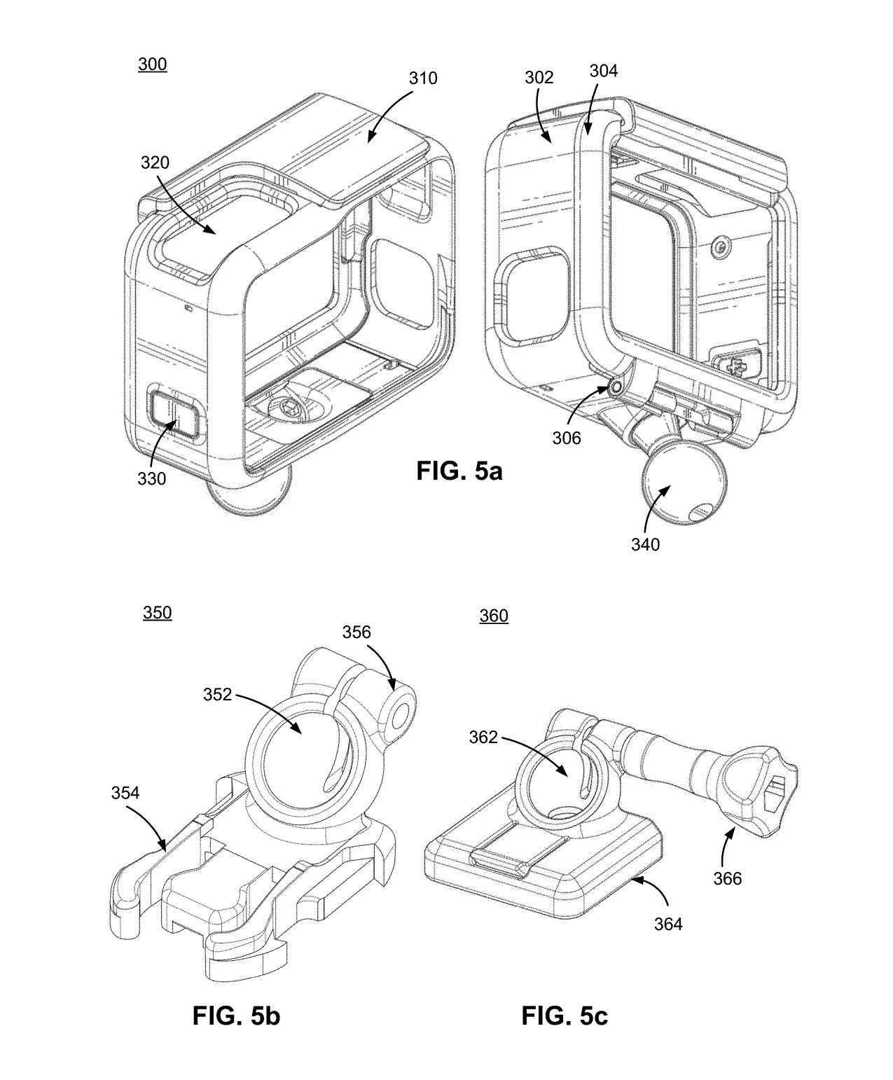

FIG. 5a illustrates a perspective view of an additional camera frame, according to one embodiment. The camera frame 300 of FIG. 5a includes a front portion 302 and a rear portion 304, rotatably coupled together by a hinge mechanism 306. The camera frame 300 of FIG. 5a also includes a latch mechanism 310 different than the latch mechanism 200 described above. The latch mechanism 310, when configured in an open configuration, allows the rear portion 304 to rotate away from the front portion 302 of the camera frame 300, allowing for the insertion of a camera into or the removal of a camera from the camera frame. In a closed configuration, the latch mechanism 310 secures the rear portion 304 of the frame to the front portion 302 of the frame, thereby securely enclosing a camera within the frame 300. The a front portion of the latch mechanism 310 (the portion closest to the front of the camera frame 300) can be lifted upwards and away from the camera frame to reconfigure the latch mechanism from the closed configuration to the open configuration, and can be pressed downwards towards the camera frame to reconfigure the latch mechanism from the open configuration to the closed configuration.

The camera frame 300 includes an opening 320 configured to substantially align with the shutter button of a camera (such as the shutter button 110 described above) when a camera is securely enclosed within the frame. Such a configuration beneficially allows a user to access a shutter button of a camera through the camera frame 300. The camera frame 300 also includes a button 330 configured to substantially align with a camera button (such as the camera button 116 described above) when a camera is securely enclosed within the frame. Such a configuration beneficially enables a user to interact with a camera button via the button 330, as pressing on the button 330 reciprocally presses on a button of the camera.

The camera frame 300 also includes a ball component 340 protruding from a rear surface of the frame 300. The ball component 340 is configured for insertion into a reciprocal socket component of a lower mount component. FIGS. 5b and 5c illustrate lower mount components with socket components. The lower mount component 350 of FIG. 5b includes a socket component 352 configured to partially enclose the ball component 340 of the camera frame 300, rotatably coupling the camera frame to the lower mount component. The lower mount component 350 includes prongs 354 (similar to the prongs 180a and 180b described above) configured to couple the lower mount component to a base mount component (such as the base mount component 188 described above). The lower mount component 350 also includes a tightening mechanism 356 configured to receive a screw, tightening the tightening mechanism in a closed configuration and securing the ball component 340 within the socket component 352 (and similarly, loosening the tightening mechanism in an open configuration and allowing for the removal of the ball component from or insertion of the ball component into the socket component). The lower mount component 360 similarly includes a socket component 362, and includes a screw 366 inserted into the tightening mechanism of the lower mount component. The lower mount component 360 includes an alternative bottom component 364 configured to couple the lower mount component to a base component. Additional description of the ball and socket-type coupling mechanisms can be found in U.S. patent application Ser. No. 14/521,458, filed Oct. 22, 2014, the contents of which are hereby incorporated by reference in their entirety.

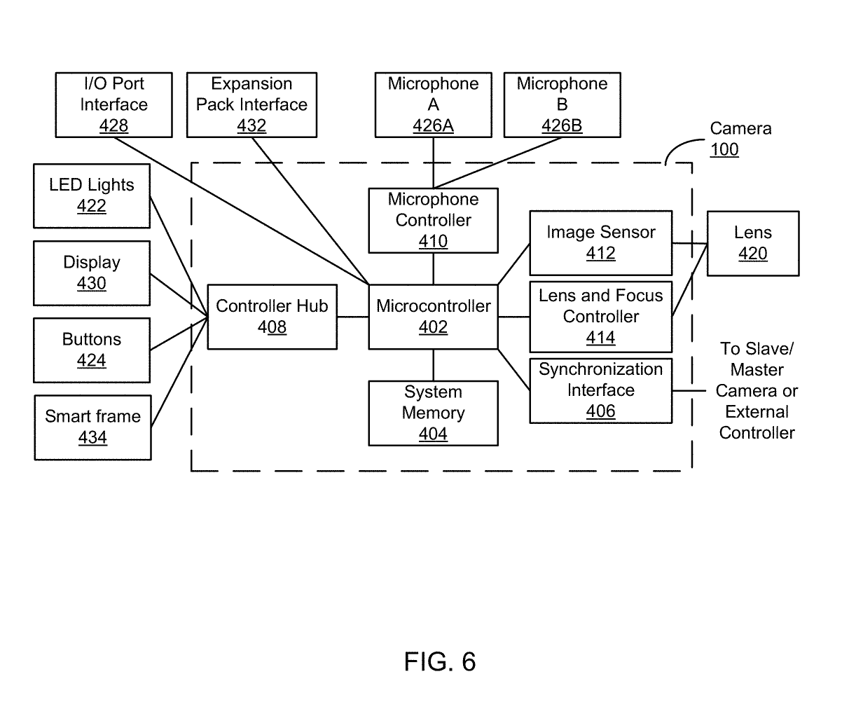

FIG. 6 illustrates an example high-level block diagram of a camera system 100, according to one embodiment. The camera 100 of the embodiment of FIG. 6 includes one or more microcontrollers 402, a system memory 404, a synchronization interface 406, a controller hub 408, one or more microphone controllers 410, an image sensor 412, a lens and focus controller 414, one or more lenses 420, one or more LED lights 422, one or more buttons 424, one or more microphones 426, an I/O port interface 428, a display 430, an expansion pack interface 432, and a smart frame 434.

The camera 100 includes one or more microcontrollers 402 (such as a processor) that control the operation and functionality of the camera 400. For instance, the microcontrollers 402 can execute computer instructions stored on the memory 404 to perform the functionality described herein. Example camera functions, configurations, and modes include: picture settings (quality, scene mode, color balance), shutter speed (fast/slow), exposure time, ISO sensitivity, zoom %, video or photo, flash properties, timer countdown, time lapse, picture type (e.g. panorama), playback controls (e.g. fast forward, rewind), and audio settings. Additional functionalities may include “quick capture” abilities (e.g. immediate photo/video capturing when camera is initially off) or assigning a tag to the next video or photo (e.g. marking the importance of or categorizing the content).

A lens and focus controller 414 is configured to control the operation, configuration, and focus of the camera lens 420, for instance based on user input or based on analysis of captured image data. The image sensor 412 is a device capable of electronically capturing light incident on the image sensor 412 and converting the captured light to image data. The image sensor 412 can be a CMOS sensor, a CCD sensor, or any other suitable type of image sensor, and can include corresponding transistors, photodiodes, amplifiers, analog-to-digital converters, and power supplies.

A system memory 404 is configured to store executable computer instructions that, when executed by the microcontroller 402, perform the camera functionalities described herein. The system memory 404 also stores images captured using the lens 420 and image sensor 412. The memory 404 can include volatile memory (e.g., random access memory (RAM)), non-volatile memory (e.g., a flash memory), or a combination thereof.

A synchronization interface 406 is configured to communicatively couple the camera 100 with external devices, such as a remote control, another camera (such as a slave camera or master camera), a computer, or a smartphone. The synchronization interface 406 may transfer information through a network, which allows coupled devices, including the camera 100, to exchange data other over local-area or wide-area networks. The network may contain a combination of wired or wireless technology and make use of various connection standards and protocols, such as WiFi, IEEE 1394, Ethernet, 802.11, 4G, or Bluetooth.

A controller hub 408 transmits and receives information from user I/O components. In one embodiment, the controller hub 408 interfaces with the LED lights 422, the display 430, and the buttons 424. However, the controller hub 408 can interface with any conventional user I/O component or components. For example, the controller hub 408 may send information to other user I/O components, such as a speaker. As described below, the controller hub 408 can interface with a smart frame 434, enabling a user to configure the camera 100 via the smart frame 434 and controller hub 408.

A microphone controller 410 receives and captures audio signals from one or more microphones, such as microphone 426A and microphone 426B. Although the embodiment of FIG. 6 illustrates two microphones, in practice, the camera can include any number of microphones. The microphone controller 410 is configured to control the operation of the microphones 126. In some embodiments, the microphone controller 410 selects which microphones from which audio data is captured. For instance, for a camera 100 with multiple microphone pairs, the microphone controller 410 selects one microphone of the pair to capture audio data.

Additional components connected to the microcontroller 402 include an I/O port interface 428 and an expansion pack interface 432. The I/O port interface 428 may facilitate the camera 100 in receiving or transmitting video or audio information through an I/O port. Examples of I/O ports or interfaces include USB ports, HDMI ports, Ethernet ports, audioports, and the like. Furthermore, embodiments of the I/O port interface 428 may include wireless ports that can accommodate wireless connections. Examples of wireless ports include Bluetooth, Wireless USB, Near Field Communication (NFC), and the like. The expansion pack interface 432 is configured to interface with camera add-ons and removable expansion packs, such as an extra battery module, a wireless module, and the like.

### Smart Frame Overview

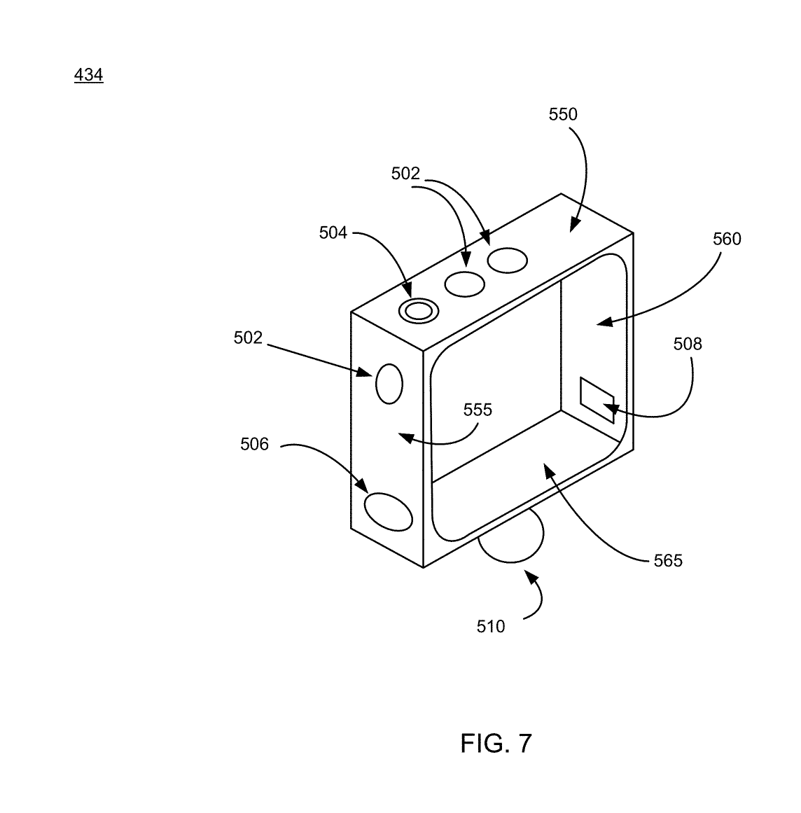

FIG. 7 illustrates a perspective view of a smart frame 434, according to one embodiment. The smart frame 434 comprises a top face 550, a left face 555, a right face 560, a bottom face 565, input mechanisms 502, 504, and 506 (referred to individually as “input mechanism 502” herein), a communication port 508, and a mounting component 510. The smart frame 434 securely encloses a camera 100 by contacting the circumferential faces (e.g. the top, left, right, and bottom faces) of the camera body without occluding the front or rear faces of the camera body. In other embodiments, the smart frame 434 can include additional, fewer, or different components and/or configurations of features than those illustrated herein. These various embodiments of the smart frame 434 demonstrate the increased interactive and interface configurability and functionality of a smart frame 434 that securely encloses a camera 100. In contrast, a camera 100, by itself, may have just two or fewer input mechanisms that may be difficult to access during use in sports or action environments.

The smart frame 434 includes a communication port 508 on the right face 560 that substantially aligns and communicatively couples with the camera I/O port 114 when the smart frame securely encloses the camera 100. The communication port 508 enables the transmission of signals corresponding to interactions with input mechanisms of the smart frame to the camera 100 via the I/O port 114. Further, the communication port 508 enables the transfer of power from a battery of the camera 100 to the smart frame, beneficially enabling the smart frame without requiring the smart frame to include a battery. It should be noted that although the communication port 508 is illustrated in FIG. 7 on the right face 560 of the smart frame 434, in other embodiments, the communication port can be located on any interior face of the smart frame.

Types of communication ports 508 include, but are not limited to, USB (type A, B, C), micro USB, HDMI, Lightning, DVI, VGA, and DisplayPort. The data transferred through the communication port 508 may include images, videos, media metadata, camera setting information, and camera configuration information. As shown in one embodiment in FIG. 7, the communication port 508 is located on the internal side of the right face 560 of the frame 434. The communication port 508 may protrude from the surface of the right face 560 for insertion into the reciprocal cavity of the I/O port 114 on the camera 100 when the frame securely encloses the camera. In some embodiments, the communication port 508 can fold into a recess within the right face 560 of the frame 434 when the frame is not in use so that the port doesn't protrude from the surface of the right face.

In some embodiments, the communication port 508 includes a mechanism surrounding the communication port 508 that, when the smart frame securely encloses the camera 100, creates a water-proof or air-tight seal around the coupling of the communication port 508 and the I/O port 114. In another embodiment, in lieu of a physical communication port 508, the smart frame 434 includes a power source (e.g. battery) within or accessible to the smart frame, and communicates with the camera 100 using a wireless communication protocol, such as WiFi, Bluetooth, 4G data, and the like.

The smart frame 434 includes programmable input mechanisms 502 that may each be programmed to, when interacted with by a user, configure a camera into a pre-determined configuration or mode, or to perform user-desired camera functions. The smart frame 434 can include one or more input mechanisms 502 on each of one or more exterior smart frame surfaces. In the embodiment of FIG. 7, the top surface 550 includes two input mechanisms 502 and the left surface 555 includes one input mechanism 502. In one embodiment, the smart frame 434 includes additional input mechanisms configured to physically or communicatively transfer inputs from the additional input mechanisms to one or more input mechanisms of the camera 100. For example, in the embodiment of FIG. 7, the smart frame 434 includes buttons 504 and 506 on the top surface 550 and left surface 555, respectively, substantially aligning with the outer shutter button 130 and camera button 116, respectively, and transferring physical compressions by a user to the buttons 130 and 116.

In some embodiments, the input mechanisms 502, 504, and 506 may be physical buttons that receive input from a user through compression. In some embodiments, input mechanisms 502 may be electronic or digital buttons that register an input through electromagnetic or capacitive means. For example, a user may use a finger to touch the electronic button, thereby registering a capacitive input. As illustrated in FIG. 7, the input mechanisms may be circular in shape. In some embodiments, the input mechanisms may be any shape and may be larger or smaller than shown in FIG. 7. Input mechanisms may be shaped and sized differently to differentiate their different functionalities.

As noted above, in some embodiments, the input mechanisms are spring loaded or physically compressible, thereby enabling kinesthetic feedback for a user, while in other embodiments, the input mechanisms are not necessarily physically compressible, but instead provide haptic feedback for a user. In some embodiments, one or more of the input mechanisms of the frame 434 or the camera 100 itself are associated with intervals of compression, each interval of compression associated with a different input. For example, an input mechanism can be a spring loaded button that when compressed between 25% and 50% provides a first input value to the camera 100, when compressed between 50% and 75% provides a second input value to the camera, and when compressed between 75% and 100% provides a third input value to the camera. Continuing with this example, each of such input values can be associated different camera settings or modes (e.g., the first input value can be associated with the capture of video, the second input value can be associated with capturing an image, and the third input value can be associated with tagging a moment or highlight within video. Alternatively, each of such input values can be associated with the same camera setting or mode (e.g., the first input value can be associated with the capture of video in slow motion or at 30 fps, the second input value can be associated with the capture of video at regular speed or at 60 fps, and the third input value can be associated with the capture of video at fast forward speed or at 120 fps). By enabling a single input mechanism to be associated with multiple input values, a user can beneficially configure a camera to operate in multiple modes using a single button.

FIG. 7 illustrates one embodiment of the location of input mechanisms 502, 504, and 506. As displayed, two input mechanisms 502 and one additional input mechanism 504 are located on the exterior side of the top face 550 of the smart frame 434. One input mechanism 502 and one additional input mechanism 506 are aligned on the left face 555 of the smart frame 434. A person skilled in the art can appreciate that the number of input mechanisms on each face may vary. For example, in one embodiment, the left face 555, top face 550 and right face 560 may each have one input mechanism on the external surface. In another embodiment, some faces may have no input mechanisms whereas other faces may have more than one input mechanism. In one embodiment, more than one input mechanisms on a single face may be aligned along the longitudinal axis of the face.

Each input mechanism 502 on the smart frame 434 may be programmed to correspond to a particular camera function, mode, or configuration. Upon receiving a user input via the input mechanism 502, the smart frame 434 transmits the input to the camera 100, and the camera, upon receiving the input, performs a function or configures itself to operate in a camera mode associated with the input. For example, the function, mode, or configuration associated with an input may include capturing a quick image, starting/ending a video recording, and/or changing properties associated with flash or with image capture. In another embodiment, a user may create one or more camera profiles stored on the camera 100, each associating each input mechanism 502 with a camera function, setting, or configuration. In such embodiments, a user can select a camera profile when using the camera 100, thereby programming each input mechanism 502 with the function, configuration, or setting associated with the input mechanism by the selected profile. In some embodiments, a user can switch between camera profiles by interacting with an input mechanism 502 of the frame 434.

The input mechanisms 502 of the smart frame 434 may be initially pre-programmed by the manufacturer to correspond to default camera functions, modes, or configurations. In another embodiment, the functions, modes, and configurations associated with the input mechanisms 502 can be programmed by a user. The function, mode, or configuration associated with each input mechanism can be stored locally on the smart frame 434, thereby enabling the programmed setting, mode, or configuration of each input mechanism to be transferrable when the smart frame 434 is coupled to a different camera 100. In another embodiment, the programmed setting, mode, or configuration of each input mechanism is stored on the camera 100. When a camera 100 stores programmed associations between frame input mechanisms and functions, modes, and configurations, the camera functions, modes, or configurations can be automatically mapped to the input mechanisms 502 of any smart frame 434 coupled to the camera. Alternatively, when a smart frame 434 secures a new camera 100 that does not contain previously programmed associations between input mechanisms and functions, modes, or configurations, each input mechanism of the frame may be mapped to a default or pre-programmed camera function, mode, or configuration.

In some embodiments, each input mechanism 502 can be associated with a different camera function, mode, or configuration. In some embodiments, all of the input mechanisms 502 on a particular face are programmed with similar camera functions, modes, or configurations. For example, the one or more input mechanisms 502 located on the top face 550 may be associated with different camera functions (e.g. capture instant picture, begin capture of instant video), whereas the one or more input mechanisms 502 located on the left face 555 may correspond to different camera modes (e.g. high dynamic range (HDR) mode, night mode, flash mode). In some embodiments, each of a plurality of successive user inputs on a single input mechanism 502 (e.g. a single tap, double tap or triple tap input) may be associated with a specific camera function, mode, or configuration. In some embodiments, each of a plurality of durations of a user input (e.g. holding a button down between 1-2 seconds vs. holding the button down for 2 or more seconds) may be associated with a specific camera function, mode, or configuration.

In some embodiments, camera functions, modes, or configurations can be combined by simultaneously providing two or more user inputs. For example, the camera 100 can instantly take a picture in HDR mode if the user simultaneously interacts with an input mechanism that corresponds to the quick capture of an image and an input mechanism that corresponds to an HDR mode. In another embodiment, a user can program a camera function, mode, or configuration corresponding to the simultaneous interaction with two or more input mechanisms that is different from the camera function, mode, or configuration associated with the interaction with each individual input mechanism of the two or more input mechanisms.

In some embodiments, the bottom surface 565 of the smart frame includes a mounting component to interface with a lower mount component. As illustrated in FIG. 7, the mounting component may be a ball component 510 protruding from bottom surface 565 that is configured for insertion into a reciprocal socket of a lower mount component. In some embodiments, the mounting component is a first plurality of protrusions 134 as illustrated in FIG. 2 that can interlock with a reciprocal plurality of protrusions of a lower mount component. In some embodiments, the mounting device includes a turnable handscrew 199 coupled to a mount component 160. The lower mount component may be further secured to an object or surface, such as a helmet, thereby securing the frame 434 and the camera 100 to the object or surface when the frame is coupled to the lower mount component.

In another embodiment, the smart frame 434 includes sensors (e.g. GPS receiver, accelerometers, and the like) that can provide additional information to the camera through the communication port 508. Such information can be included within media captured by the camera. For example, the smart frame can capture location data via a GPS receiver concurrent with the capture of image data by a camera in response to the interaction with a smart frame input mechanism by a user, can provide the location data to the camera via the communication port, and the camera can store the location data within metadata of the image data.

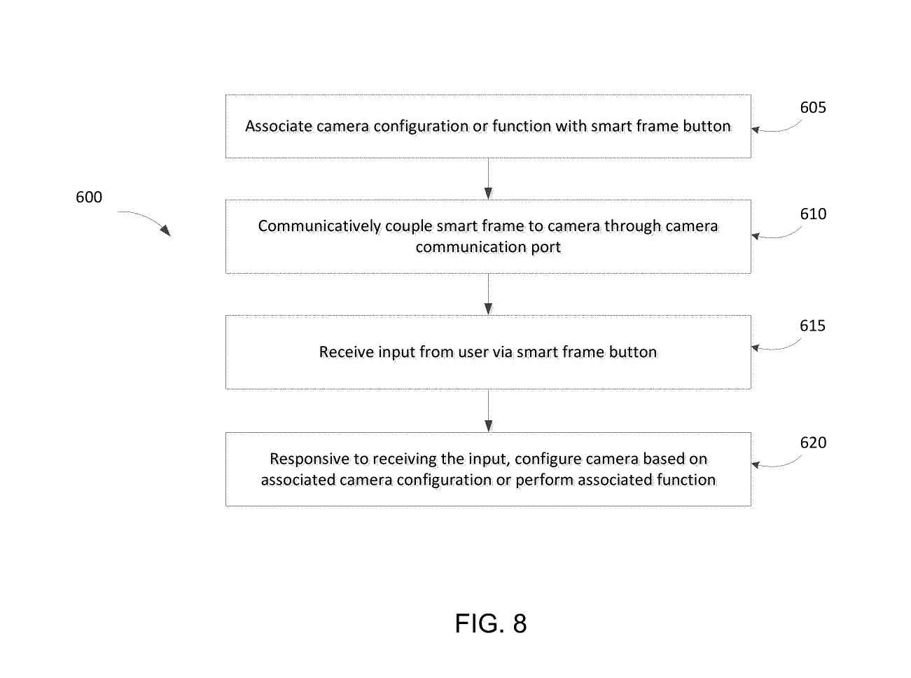

FIG. 8 is a flow chart depicting the method of configuring the smart frame enclosure to interface with the camera. A camera configuration or function is associated 605 with a smart frame button. For instance, a user can select a function via a camera interface, can select a button of the smart frame, and can associate the selected function and smart frame button. The smart frame is communicatively coupled 610 to a camera 100 via a camera communication port 114. An input is received 615 from a user via the smart frame button, and in response, the camera is configured or a camera function is performed 620 based on a configuration or function associated with the smart frame button.

### Additional Configuration Considerations

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skilled in the art will appreciate still additional alternative structural and functional designs for smart frames as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A camera frame comprising:
an enclosure body configured to removably enclose a camera, the enclosure body comprising:
a plurality of interior faces, each interior face configured to abut one of a top surface of the camera, a right surface of the camera, a left surface of the camera, and a bottom surface of the camera when the enclosure body encloses the camera;
a communication port protruding from one of the plurality of interior faces, the communication port substantially aligning with and configured for insertion into a reciprocal camera communication port when the enclosure body encloses the camera;
a plurality of exterior faces, the plurality of faces comprising a top face, left face, right face, and bottom face, one or more of the plurality of faces including one or more programmable input mechanisms, each programmable input mechanism associated with a pre-determined camera function, wherein each programmable input mechanism, when interacted with by a user of the camera frame, generates a signal transmitted to the camera via the communication port, the camera configured to, in response to receiving the signal, perform the camera function associated with the input mechanism interacted with by the user; and
a coupling mechanism configured to couple with a camera mount.

2. The camera frame of claim 1, wherein power is provided from the camera to the camera frame via the communication port.

3. The camera frame of claim 1, further comprising one or more additional input mechanisms located on one or more of the plurality of faces that substantially align with one or more buttons on the camera when the enclosure body encloses the camera.

4. The camera frame of claim 3, wherein each additional input mechanism comprises a button that, when compressed, compresses in turn an aligned camera button.

5. The camera frame of claim 1, wherein at least one pre-determined camera function comprises one of: capturing an image, beginning capture of video, ending capture of video, selecting a camera setting, and changing a camera configuration.

6. The camera frame of claim 1, wherein the associations between each programmable input mechanism and the associated pre-determined camera functions are stored by the camera frame.

7. The camera frame of claim 1, wherein each input mechanism of the camera frame can be reprogrammed to be associated with a different camera function.

8. The camera frame of claim 1, wherein the coupling mechanism is a ball component configured for insertion into a reciprocal socket component of a camera mount.

9. A method comprising:
communicatively coupling a camera to a camera frame enclosing the camera, the camera frame comprising one or more programmable input mechanisms;
associating a first input mechanism of the camera frame with a camera function;
receiving an input from a user at the first input mechanism; and
responsive to receiving the input, performing, by the camera, the camera function associated with the first input mechanism.

10. The method of claim 9, wherein the camera function associated with the first input mechanism comprises one of: capturing an image, beginning capture of video, ending capture of video, selecting a camera setting, and changing a camera configuration.

11. The method of claim 9, further comprising:
associating a second input mechanism of the camera frame with a second camera function;
receiving an input from a user at the second input mechanism of the smart frame; and
responsive to receiving the input at the second input mechanism, performing, by the camera, the second camera function.

12. The method of claim 9, further comprising:
associating the first input mechanism of the camera frame with a second camera function;
receiving a second input from a user at the first input mechanism of the smart frame; and
responsive to receiving the second input, performing, by the camera, the second camera function.

13. A camera frame comprising:
an interior surface configured to abut an outside surface of a camera when the camera is enclosed by the camera frame;
a communication port protruding from the interior surface, the communication port substantially aligning with and configured for insertion into a reciprocal camera communication port;
an exterior surface including one or more programmable input mechanisms, each programmable input mechanism associated with a pre-determined camera function, wherein each programmable input mechanism, when interacted with by a user of the camera frame, instructs the camera, via the communication port, to perform the camera function associated with the input mechanism.

14. The camera frame of claim 13, wherein power is provided from the camera to the camera frame via the communication port.

15. The camera frame of claim 13, further comprising one or more additional input mechanisms located on the exterior surface of the camera frame that substantially align with one or more buttons on the camera when the camera is enclosed by the camera frame.

16. The camera frame of claim 15, wherein each additional input mechanism comprises a button that, when compressed, compresses in turn an aligned camera button.

17. The camera frame of claim 13, wherein at least one pre-determined camera function comprises one of: capturing an image, beginning capture of video, ending capture of video, selecting a camera setting, and changing a camera configuration.

18. The camera frame of claim 13, wherein an association between each programmable input mechanism and the associated pre-determined camera functions are stored by the camera frame.

19. The camera frame of claim 13, wherein each input mechanism of the camera frame can be reprogrammed to be associated with a different camera function.

20. The camera frame of claim 13, further comprising a ball component configured for insertion into a reciprocal socket component of a camera mount.
